(19) United States
(12) Patent Application Publication
(10) Pub. No.: US 2017/0272919 A1
(43) Pub. Date: Sep. 21, 2017

(54) METHOD FOR PROVIDING PUSH-TO-TALK COMMUNICATION SERVICE IN A WIRELESS COMMUNICATIONS SYSTEM

(71) Applicant: Quanta Computer Inc., Taoyuan City (TW)

(72) Inventors: Yu-Hsing LIN, Taoyuan City (TW); Chen-Che HUANG, Taoyuan City (TW); Chung-Kuo HUANG, Taoyuan City (TW); Yu-Chuan CHANG, Taoyuan City (TW); Chun-Hsiung FANG, Taoyuan City (TW)

(21) Appl. No.: 15/190,889

(22) Filed: Jun. 23, 2016

(30) Foreign Application Priority Data
Mar. 15, 2016 (TW) 105107870

(51) Int. Cl. H04W 4/10

(52) U.S. Cl. CPC H04W 4/10

(57) ABSTRACT

A method for providing push-to-talk communication service is provided. The method is used in a broadcast server and includes: receiving an invitation message from a calling device; broadcasting a plurality of push-to-talk invitation messages to a plurality of called devices identified in a group list associated with the calling device; and receiving a plurality of push-to-talk acknowledgment messages from the called devices to establish a first voice transmission path between the broadcast server and the called devices.

### CROSS REFERENCE TO RELATED APPLICATIONS

This application claims priority of Taiwan Patent Application No. 105107870, filed on Mar. 15, 2016, the disclosures of which are incorporated herein by reference in their entirety.

### BACKGROUND OF THE INVENTION

Field of the Invention

The invention relates to a wireless communications system. More specifically, the present invention relates to a method and a device for providing push-to-talk (PTT) communication service in a wireless communications system.

Description of the Related Art

Today, cellular radio networks are widely used by private and business users. Such networks typically provide a full duplex point-to-point voice communication service between a calling device and a called device. A service that is becoming popular in cellular radio networks is the Push-to-Talk (PTT) services. PTT calls are half duplex one-to-one or one-to-many communications: while one person speaks, the other one or more persons must listen. The right to speak is granted by pressing a push-to-talk button on a first come/first serve basis.

However, in the prior art, it is not clear how to use the PTT service to communicate with a specific group of people. Therefore, a method and a device for providing PTT communication service are needed to solve the problems described above.

### BRIEF SUMMARY OF THE INVENTION

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

A method for providing push-to-talk (PTT) communication service in a wireless communications system is provided.

In a preferred embodiment, a method for providing push-to-talk communication service is provided in the invention. The method is used in a broadcast server, and comprises: receiving an invitation message from a calling device; broadcasting a plurality of push-to-talk (PTT) invitation messages to a plurality of called devices identified in a group list associated with the calling device; and receiving a plurality of push-to-talk acknowledgment messages from the called devices to establish a first voice transmission path between the broadcast server and the called devices.

In some embodiments, after receiving the invitation message from the calling device, the method further comprises: transmitting a group list command to a database server according to the invitation message to request the group list associated with the calling device; and receiving the group list transmitted from the database server. In some embodiments, after establishing the first voice transmission path, the method further comprises: forwarding a one-way message from the calling device to the called devices. In some embodiments, the one-way message is a voice message. In some embodiments, before receiving the invitation message from the calling device, the method further comprises: receiving an establishment message transmitted from the calling device; determining whether the broadcast server is idle; and transmitting an establishment acknowledgement message to the calling device when the broadcast server is idle, wherein the establishment acknowledgement message includes an address corresponding to the broadcast server. In some embodiments, the broadcast server is connected to a main broadcast server; before receiving the invitation message from the calling device, the method further comprises: receiving, by the main broadcast server, an establishment message transmitted from the calling device; determining, by the main broadcast server, whether the broadcast server is idle; and transmitting, by the main broadcast server, an establishment acknowledgement message to the calling device when the broadcast server is idle, wherein the establishment acknowledgement message includes an address corresponding to the broadcast server. In some embodiments, after receiving the invitation message from the calling device, the method further comprises: transmitting an invitation acknowledgement message to the calling device to establish a second voice transmission path between the broadcast server and the calling device. In some embodiments, the broadcast server further comprises a management interface; the broadcast server transmits the group list command to the database server via the management interface, and receives the group list transmitted from the database server via the management interface. In some embodiments, the group list command at least includes an identifier of the calling device. In some embodiments, the push-to-talk invitation messages at least include an address of the broadcast server, an identifier of the calling device and push-to-talk information.

### BRIEF DESCRIPTION OF DRAWINGS

The accompanying drawings are included to provide a further understanding of the invention, and are incorporated in and constitute a part of the present invention. The drawings illustrate implementations of the invention and, together with the description, serve to explain the principles of the invention. It should be appreciated that the drawings are not necessarily to scale as some components may be shown out of proportion to the size in actual implementation in order to clearly illustrate the concept of the present invention.

FIG. 1A shows a schematic diagram illustrating the architecture of a communications system in accordance with one embodiment of the invention.

FIG. 1B shows a schematic diagram illustrating the architecture of a communications system in accordance with another embodiment of the invention.

FIG. 2 shows an alternative simplified functional block diagram of a wireless communications device according to one embodiment of the present invention.

FIG. 3 is a simplified block diagram of the program code shown in FIG. 2 in accordance with one embodiment of the invention.

FIG. 4 is a message flow for providing push-to-talk communication service according to an embodiment of the present invention with reference to FIG. 1A.

FIG. 5 is a message flow for providing push-to-talk communication service according to an embodiment of the present invention with reference to FIG. 1B.

FIG. 6 is a message flow for performing push-to-talk communication service according to an embodiment of the present invention with reference to FIGS. 1A-1B.

FIG. 7 is a flow diagram illustrating a method for providing push-to-talk communication service according to an embodiment of the present invention.

### DETAILED DESCRIPTION OF THE INVENTION

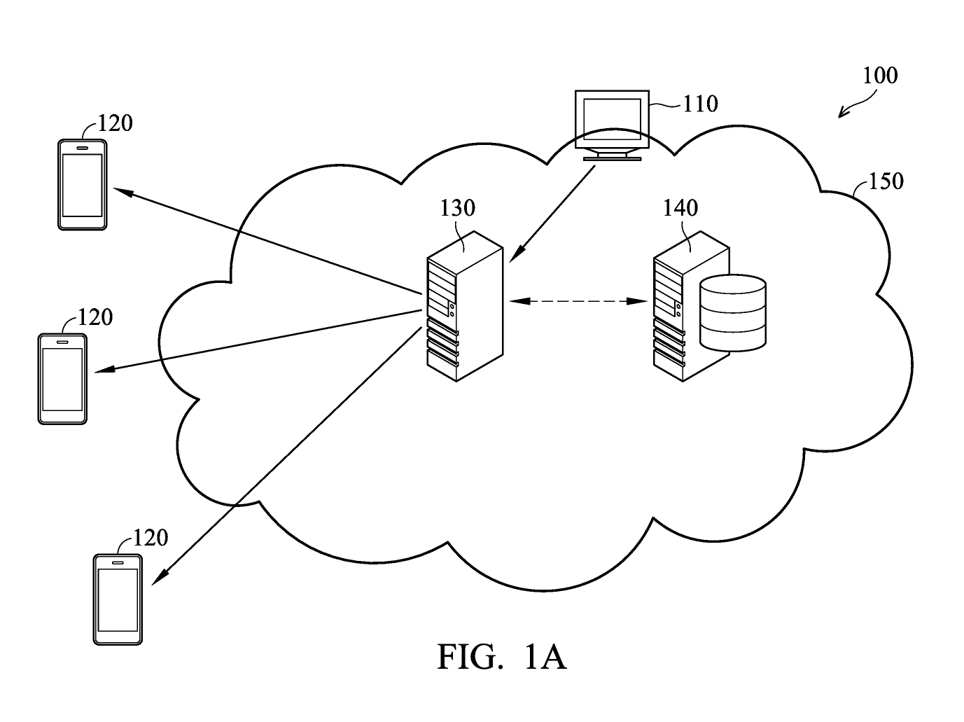

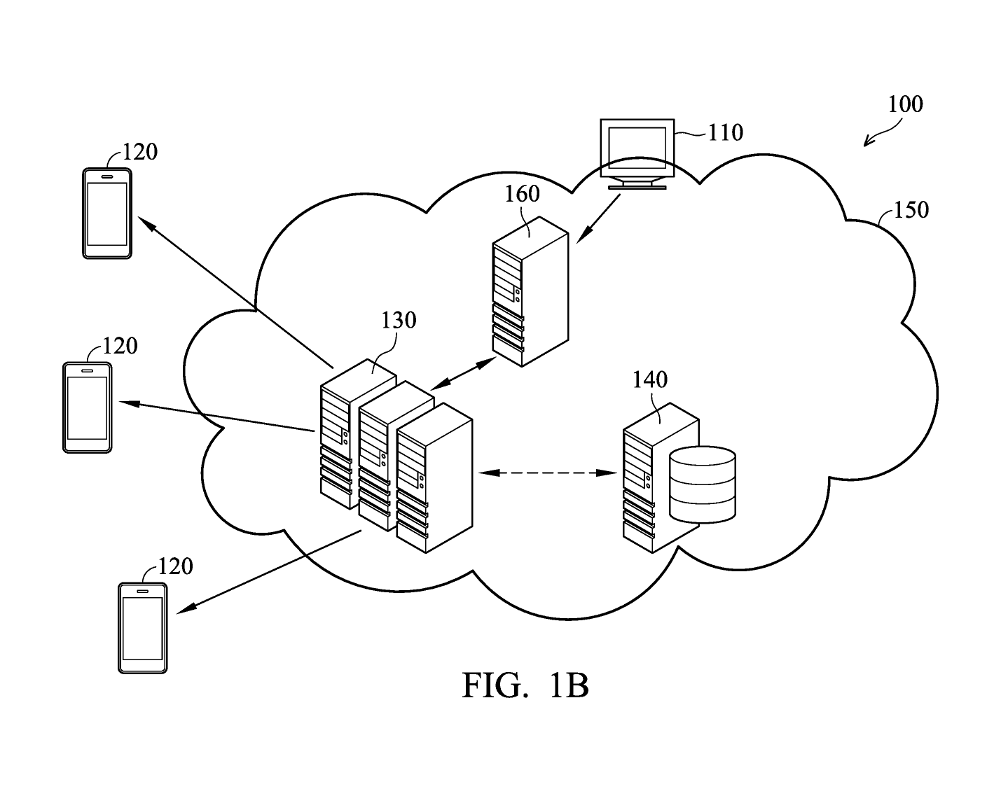

Several exemplary embodiments of the present disclosure are described with reference to FIGS. 1A through 7 which generally relate to a method for providing Push-to-Talk (PTT) service. It should be understood that the following disclosure provides various embodiments as examples for implementing different features of the present disclosure. Specific examples of components and arrangements are described in the following to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

In this description, the terms “communication device,” “wireless device,” “wireless communications device,” “PTT communication device,” “handheld device,” “mobile device,” and “handset” are used interchangeably. The terms “call” and “communication” are also used interchangeably. The term “application” as used herein is intended to encompass executable and non-executable software files, raw data, aggregated data, patches, and other code segments. The term “exemplary” means that the disclosed element or embodiment is only an example, and does not indicate any preference of user. Further, like numerals refer to like elements throughout the several views, and the articles “a” and “the” includes plural references, unless otherwise specified in the description.

FIG. 1A shows a schematic diagram illustrating the architecture of a communications system 100 in accordance with one embodiment of the invention. As shown in FIG. 1A, the communications system 100 includes a calling device 110, one or more than one called device 120, a broadcast server 130 and a database server 140. The called device 110 and one or more than one called device 120 may be a wireless communications device, such as a wireless cell phone, a personal digital assistant (PDA), a notebook computer and other devices.

The called device 110 and one or more than one called device 120 can communicate with each other via a wireless network 150, and may also communicate with the broadcast server 130 via the wireless network 150. It should be noted that although the number of called devices in FIG. 1A is three as an example, it should not be limited in the invention.

The broadcast server 130 can be coupled to the database server 140 to handle with the push-to-talk communication service management and manage a group list stored in the database server 140 and associated with the calling device. For example, when a wireless communications device is the called device 110, the group list corresponding to an identifier of the calling device 110 records all the called devices associated with the calling device 110.

FIG. 1B shows a schematic diagram illustrating the architecture of a communications system 100 in accordance with another embodiment of the invention. In FIG. 1B, the elements are the same as the illustration of the embodiment described in FIG. 1A, so the details related to the elements will be omitted. The main difference between FIG. 1B and FIG. 1A is that FIG. 1B further includes a main broadcast server 160 and a plurality of broadcast servers 130, wherein the main broadcast server 160 can be connected to the plurality of broadcast servers 130. The main broadcast server 160 is used to determine whether there is a broadcast server that is idle among the broadcast servers 130 (i.e., the broadcast server does not perform push-to-talk communication service with any group), and assigns a broadcast server that is idle to the calling device for performing the push-to-talk communication service.

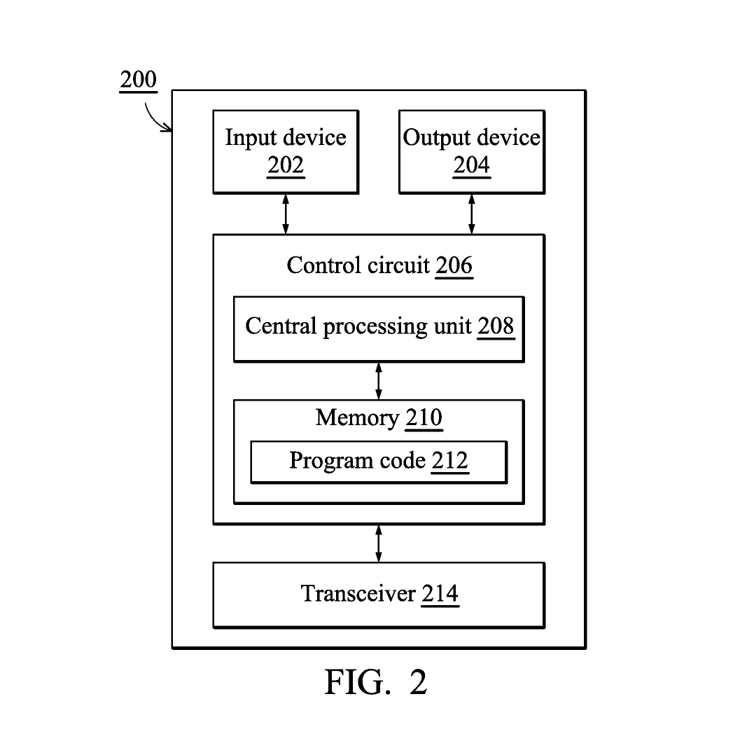

Next, turning to FIG. 2, FIG. 2 shows an alternative simplified functional block diagram of a wireless communications device 200 according to one embodiment of the present invention. As shown in FIG. 2, the wireless communications device 200 can be utilized for realizing the calling device 110, the called device 120, the broadcast server 130 and the main broadcast server 160. The wireless communications device 200 may include an input device 202, an output device 204, a control circuit 206, a central processing unit (CPU) 208, a memory 210, a program code 212, and a transceiver 214. The control circuit 206 executes the program code 212 in the memory 210 through the CPU 208, thereby controlling the operation of the wireless communications device 200. The wireless communications device 200 can receive signals input by a user through the input device 202, such as a keyboard or keypad, and can output images and sound through the output device 304, such as a monitor or speakers. The transceiver 214 is used to receive and transmit wireless signals wirelessly, deliver received signals to the control circuit 206, and output signals generated by the control circuit 206.

In another embodiment, when the wireless communications device 200 is the broadcast server 130 of FIGS. 1A-1B, the wireless communications device 200 may further include a management interface (not shown in FIGS. 1A-1B). The CPU 208 can communicate with the database server via the management interface.

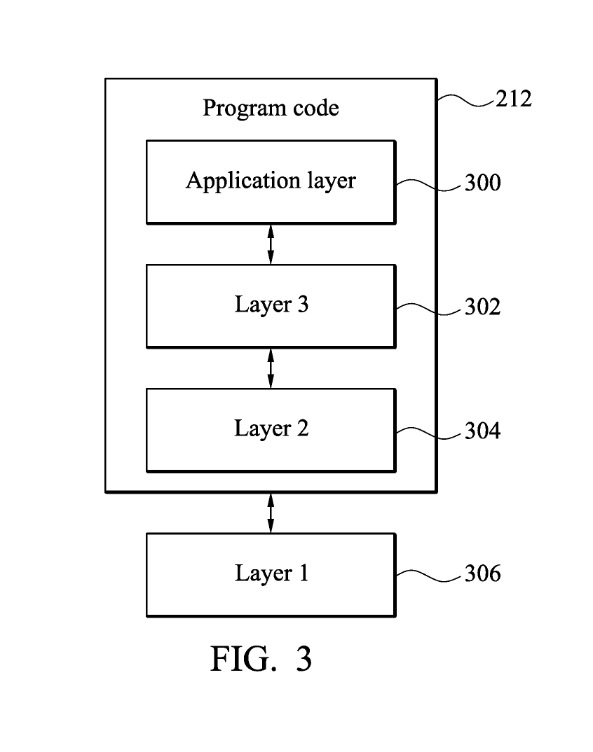

FIG. 3 is a simplified block diagram of the program code 212 shown in FIG. 2 in accordance with one embodiment of the invention. In this embodiment, the program code 212 includes an application layer 300, a Layer 3 portion 302, and a Layer 2 portion 304, and is coupled to a Layer 1 portion 306. The Layer 3 portion 302 generally performs radio resource control. The Layer 2 portion 304 generally performs link control. The Layer 1 portion 306 generally performs physical connections.

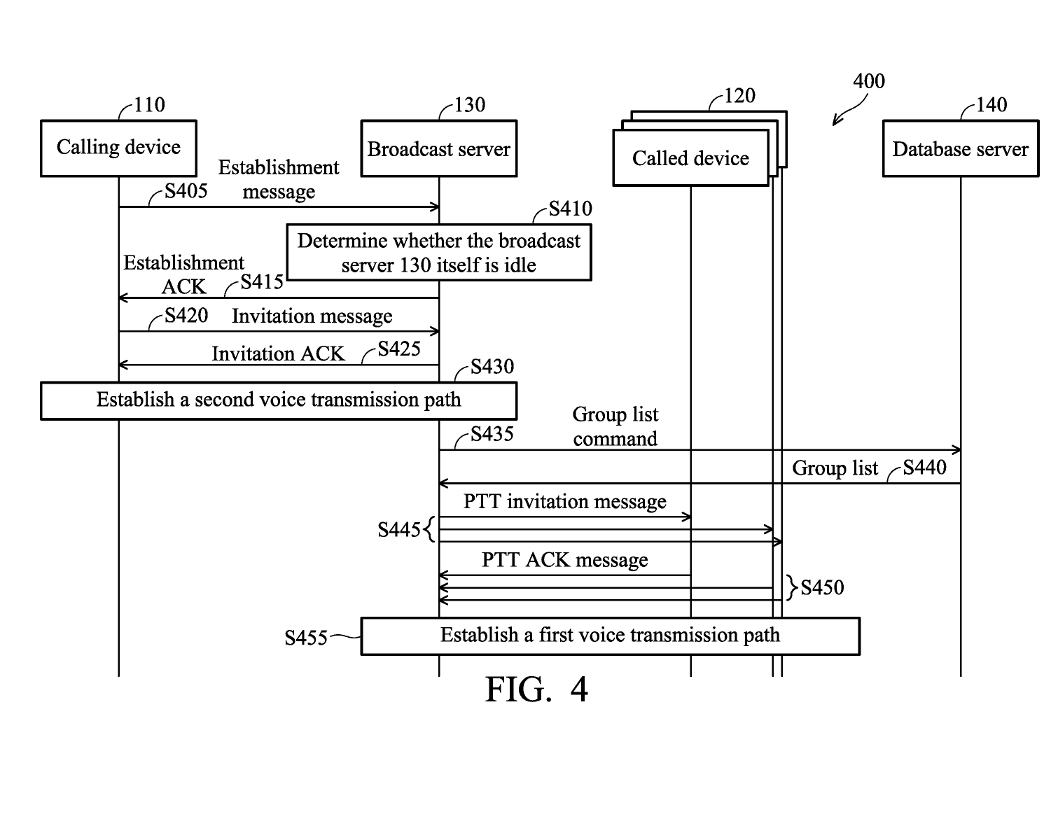

FIG. 4 is a message flow 400 for providing push-to-talk communication service according to an embodiment of the present invention with reference to FIG. 1A.

In step S405, the calling device 110 transmits an establishment message to the broadcast server 130. In step S410, the broadcast server 130 determines whether the broadcast server 130 itself is idle after receiving the establishment message. In step S415, the broadcast server 130 transmits an establishment acknowledgement (ACK) message to the calling device 110 to inform the calling device 110 that the broadcast server 130 may perform the push-to-talk communication service, wherein the establishment acknowledgement message includes an address corresponding to the broadcast server. In another embodiment, when the broadcast server 130 determines whether the broadcast server 130 itself is not idle, the broadcast server 130 may also transmit a message to the calling device 110 to inform the calling device 110 that the broadcast server 130 cannot currently perform the push-to-talk communication service.

Then, in step S420, the calling device 110 transmits an invitation message to the broadcast server 130. After receiving the invitation message from the calling device 110, in step S435, the broadcast server 130 transmits a group list command to the database server 140 according to the invitation message to request a group list associated with the calling device 110, wherein the group list command at least includes an identifier of the calling device 110. In step S440, the database server 140 transmits the group list associated with the calling device 110 to the broadcast server 130 according to the identifier of the calling device 110.

Next, after the broadcast server 130 receives the group list, in step S445, the broadcast server 130 broadcasts a plurality of push-to-talk (PTT) invitation messages to a plurality of called devices 120 identified in the group list associated with the calling device 110, wherein the PTT invitation messages at least include an address of the broadcast server 130, an identifier of the calling device 110 and push-to-talk information. In step S450, the broadcast server 130 receives push-to-talk (PTT) acknowledgment (ACK) messages from the called devices 120, respectively. Finally, in step S455, the broadcast server 130 establishes a first voice transmission path with the called devices 120.

In addition, in step S425, the broadcast server 130 may transmit an invitation acknowledgement (ACK) message to the calling device 110 to establish a second voice transmission path between the broadcast server 130 and the calling device 110 after receiving the invitation message from the calling device 110. In step S430, the broadcast server 130 establishes a second voice transmission path with the calling device 110. Note that, in the embodiment, the sequence of steps S425 to S430 and steps S435 to S455 can be reversed, or the steps S425 to S430 and steps S435 to S455 can also be carried out at the same time. It is not limited to the sequence of FIG. 4.

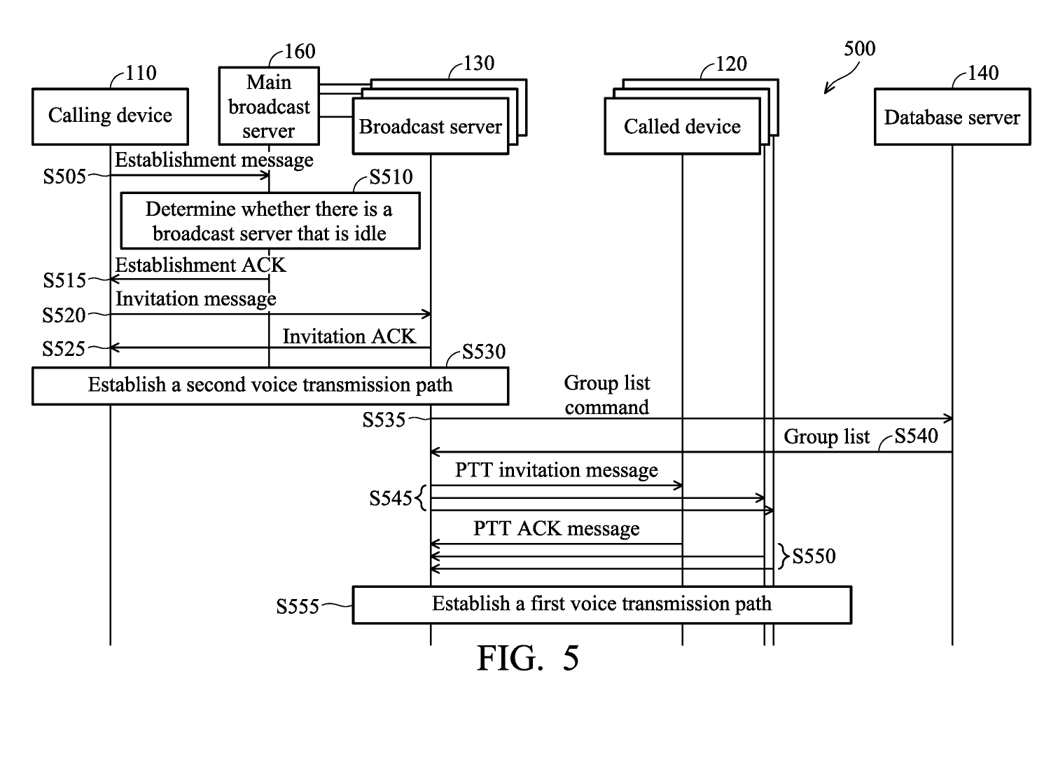

FIG. 5 is a message flow 500 for providing push-to-talk communication service according to an embodiment of the present invention with reference to FIG. 1B. In the embodiment, it is assumed that there is a main broadcast server 160 that is connected to a plurality of broadcast servers 130.

In step S505, the calling device 110 transmits an establishment message to the main broadcast server 160. After the main broadcast server 160 receives the establishment message, in step S510, the main broadcast server 160 determines whether there is a broadcast server 130 that is idle among the plurality of broadcast servers 130. After the main broadcast server 160 determines that there is a broadcast server 130 that is idle, in step S515, the main broadcast server 160 transmits an establishment acknowledgement (ACK) message to the calling device 110 to inform the calling device 110 that the broadcast server 130 that is idle can perform the push-to-talk communication service, wherein the establishment acknowledgement message includes an address corresponding to the broadcast server 130 that is idle. In another embodiment, when the main broadcast server 160 determines that there is no broadcast server 130 that is idle, the main broadcasting server 160 may transmit a message to the calling device 110 to inform the calling device that all the broadcast servers 130 cannot perform the push-to-talk communication service.

Then, in step S520, the calling device 110 transmits an invitation message to the broadcast server 130 that is idle. After receiving the invitation message from the calling device 110, in step S435, the broadcast server 130 transmits a group list command to the database server 140 according to the invitation message to request a group list associated with the calling device 110, wherein the group list command at least includes an identifier of the calling device 110. In step S540, the database server 140 transmits the group list associated with the calling device 110 to the broadcast server 130 according to the identifier of the calling device 110.

Next, after the broadcast server 130 receives the group list, in step S545, the broadcast server 130 broadcasts a plurality of push-to-talk (PTT) invitation messages to a plurality of called devices 120 identified in the group list associated with the calling device 110, wherein the PTT invitation messages at least include an address of the broadcast server 130, an identifier of the calling device 110 and push-to-talk information. In step S550, the broadcast server 130 receives push-to-talk acknowledgment (ACK) messages from the called devices 120, respectively. Finally, in step S555, the broadcast server 130 establishes a first voice transmission path with the called devices 120.

In addition, in step S525, the broadcast server 130 may transmit an invitation acknowledgement message to the calling device 110 to establish a second voice transmission path between the broadcast server 130 and the calling device 110 after receiving the invitation message from the calling device 110. In step S530, the broadcast server 130 establishes a second voice transmission path with the calling device 110. In the embodiment, the sequence of steps S455 to S530 and steps S535 to S555 can be reversed, or the steps S455 to S530 and steps S535 to S555 can also be carried out at the same time. It is not limited to the sequence of FIG. 5.

In another embodiment, one broadcast server is merely in charge of push-to-talk communication service of one calling device. When many calling devices transmit the invitation message, the main broadcast server may assign different broadcast servers to the calling devices, respectively.

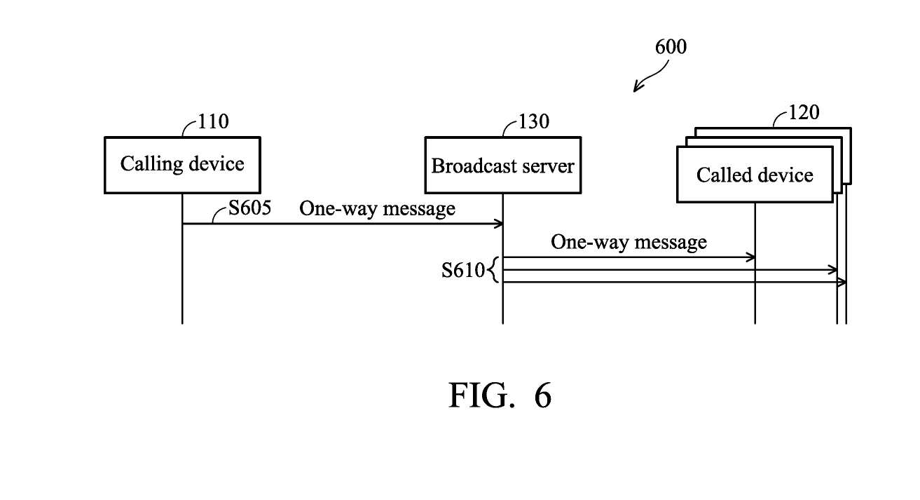

FIG. 6 is a message flow 600 for performing push-to-talk communication service according to an embodiment of the present invention with reference to FIGS. 1A-1B. After the first voice transmission path and the second voice transmission path are established, in step S605, the calling device 110 can transmit a one-way message to the broadcast server 130, wherein the one-way message is a voice message. In step S610, the broadcast server 130 forwards the one-way message to the called devices to complete the push-to-talk communication service.

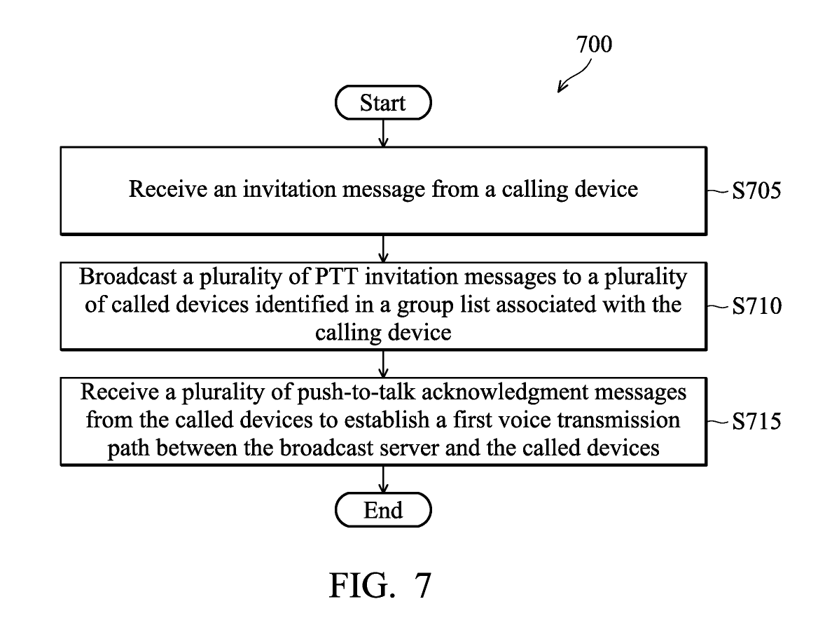

FIG. 7 is a flow diagram 700 illustrating a method for providing push-to-talk communication service according to an embodiment of the present invention. The method is used in a broadcast server. In step S705, a broadcast server receives an invitation message from a calling device. Then, in step S710, the broadcast server broadcasts a plurality of push-to-talk (PTT) invitation messages to a plurality of called devices identified in a group list associated with the calling device, wherein the push-to-talk invitation messages at least include an address of the broadcast server, an identifier of the calling device and push-to-talk information. In step S715, the broadcast server receives a plurality of push-to-talk acknowledgment messages from the called devices to establish a first voice transmission path between the broadcast server and the called devices.

In addition, the CPU 208 could execute the program code 212 to perform all of the above-described actions and steps or others described herein.

Various aspects of the invention have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using another structure, functionality, or structure and functionality in addition to or other than one or more of the aspects set forth herein.

Those with skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those skilled in the art will further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in ways that vary for each particular application, but such implementation decisions should not be interpreted as causing a departure from the scope of the present invention.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or another programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It should be understood that any specific order or hierarchy of steps in any disclosed process is an example of a sample approach. It should be understood that the specific order or hierarchy of steps in the processes may be rearranged while remaining within the scope of the present invention. The accompanying method claims present elements of the various steps in a sample order, and are not meant to be limited to the specific order or hierarchy presented.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the invention has been described by way of example and in terms of exemplary embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

1. A method for providing push-to-talk communication service, used in a broadcast server, comprising:
receiving an establishment message transmitted from a calling device;
determining whether the broadcast server is idle; and
transmitting an establishment acknowledgement message to the calling device when the broadcast server is idle, wherein the establishment acknowledgement message includes an address corresponding to the broadcast server;
receiving an invitation message from the calling device;
broadcasting a plurality of push-to-talk (PTT) invitation messages to a plurality of called devices identified in a group list associated with the calling device; and
receiving a plurality of push-to-talk acknowledgment messages from the called devices to establish a first voice transmission path between the broadcast server and the called devices,
wherein the broadcast server transmits a message to the calling device to inform the calling device that the broadcast server cannot currently perform the push-to-talk communication service when the broadcast server is not idle.

2. The method for providing push-to-talk communication service as claimed in claim 1, after receiving the invitation message from the calling device, the method further comprising:
transmitting a group list command to a database server according to the invitation message to request the group list associated with the calling device; and
receiving the group list transmitted from the database server.

3. The method for providing push-to-talk communication service as claimed in claim 1, after establishing the first voice transmission path, the method further comprising:
forwarding a one-way message from the calling device to the called devices.

4. The method for providing push-to-talk communication service as claimed in claim 3, wherein the one-way message is a voice message.

5. (canceled)

6. A method for providing push-to-talk communication service, used in a broadcast server connected to a main broadcast server, comprising:
receiving, by the main broadcast server, an establishment message transmitted from a calling device;
determining, by the main broadcast server, whether the broadcast server is idle; and
transmitting, by the main broadcast server, an establishment acknowledgement message to the calling device when the broadcast server is idle, wherein the establishment acknowledgement message includes an address corresponding to the broadcast server;
receiving, by the broadcast server, an invitation message from the calling device;
broadcasting, by the broadcast server, a plurality of push-to-talk (PTT) invitation messages to a plurality of called devices identified in a group list associated with the calling device; and
receiving, by the broadcast server, a plurality of push-to-talk acknowledgment messages from the called devices to establish a first voice transmission path between the broadcast server and the called devices,
wherein the main broadcast server transmits a message to the calling devices to inform the calling devices that the broadcast server cannot currently perform the push-to-talk communication service when the broadcast server is not idle.

7. The method for providing push-to-talk communication service as claimed in claim 1, after receiving the invitation message from the calling device, the method further comprising:
transmitting an invitation acknowledgement message to the calling device to establish a second voice transmission path between the broadcast server and the calling device.

8. The method for providing push-to-talk communication service as claimed in claim 2, wherein the broadcast server further comprises a management interface; the broadcast server transmits the group list command to the database server via the management interface, and receives the group list transmitted from the database server via the management interface.

9. The method for providing push-to-talk communication service as claimed in claim 2, wherein the group list command at least includes an identifier of the calling device.

10. The method for providing push-to-talk communication service as claimed in claim 1, wherein the push-to-talk invitation messages at least include an address of the broadcast server, an identifier of the calling device and push-to-talk information.
